(19) United States
(12) Patent Application Publication
(10) Pub. No.: US 2017/0315718 A1
(43) Pub. Date: Nov. 2, 2017

(54) HANDWRITTEN CHARACTER INPUT DEVICE, IMAGE FORMING APPARATUS AND HANDWRITTEN CHARACTER INPUT METHOD

(71) Applicant: KYOCERA Document Solutions Inc., Osaka (JP)

(72) Inventors: Crescencio Sabal, Osaka (JP); Evan Wilson Benitez, Osaka (JP); Nolan Iway, Osaka (JP); Charity Lomosbog, Osaka (JP); Jobern Loretizo, Osaka (JP); Rojie Gomez, Cebu (PH)

(21) Appl. No.: 15/171,247

(22) Filed: Jun. 2, 2016

(30) Foreign Application Priority Data
Apr. 27, 2016 (JP) 2016-089878

(51) Int. Cl. G06F 3/0488; H04N 1/00; G06F 3/041; G06K 9/22

(52) U.S. Cl. CPC G06F 3/04883; G06K 9/222; G06F 3/0416; G06F 3/0412; H04N 1/00411; G06K 2209/01; G06F 2203/04104; H04N 2201/0094

(57) ABSTRACT

A handwritten character input device includes an operation display portion, a long depression detecting portion, and an operation mode control portion. The operation display portion is configured to simultaneously detect at least two touch positions. The long depression detecting portion is configured to detect a long depression operation performed to the operation display portion. The operation mode control portion is configured to, while the long depression detecting portion is detecting the long depression operation performed with a first indicator, receive a handwritten character input operation performed to the operation display portion with a second indicator.

### INCORPORATION BY REFERENCE

This application is based upon and claims the benefit of priority from the corresponding Japanese Patent Application No. 2016-089878 filed on Apr. 27, 2016, the entire contents of which are incorporated herein by reference.

### BACKGROUND

The present disclosure relates to: a handwritten character input device for inputting handwritten characters; an image forming apparatus; and a handwritten character input method.

There is known a handwritten character input device to which handwritten characters can be input via a pointing device such as a touch panel. In general, when inputting handwritten characters to this kind of handwritten character input device, the user calls a handwritten character input screen by tapping a handwritten character input start button or the like displayed on the screen. In addition, after completing input of the handwritten characters, the user closes the input screen by tapping a close button or the like.

### SUMMARY

A handwritten character input device according to an aspect of the present disclosure includes an operation display portion, a long depression detecting portion, and an operation mode control portion. The operation display portion is configured to simultaneously detect at least two touch positions. The long depression detecting portion is configured to detect a long depression operation performed to the operation display portion. The operation mode control portion is configured to, while the long depression detecting portion is detecting the long depression operation performed with a first indicator, receive a handwritten character input operation performed to the operation display portion with a second indicator.

An image forming apparatus according to another aspect of the present disclosure includes the handwritten character input device and an image forming portion. The image forming portion forms an image on a sheet based on image data.

A handwritten character input method according to a further aspect of the present disclosure includes a long depression detecting step and an operation mode control step. In the long depression detecting step, a long depression operation is detected which is performed to an operation display portion configured to simultaneously detect at least two touch positions. In the operation mode control step, while the long depression operation performed with a first indicator is detected in the long depression detecting step, a handwritten character input operation is received which is performed to the operation display portion with a second indicator.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing an outer appearance of an image forming apparatus according to an embodiment of the present disclosure.

FIG. 2 is a block diagram showing an example of the system configuration of the image forming apparatus according to an embodiment of the present disclosure.

FIG. 3 is a diagram showing an example of a display image displayed on the image forming apparatus according to an embodiment of the present disclosure.

FIG. 4 is a diagram showing an example of a display image displayed on the image forming apparatus according to an embodiment of the present disclosure.

FIG. 5 is a diagram showing an example of a display image displayed on the image forming apparatus according to an embodiment of the present disclosure.

FIG. 6 is a diagram showing an example of a display image displayed on the image forming apparatus according to an embodiment of the present disclosure.

FIG. 7 is a diagram showing an example of a display image displayed on the image forming apparatus according to an embodiment of the present disclosure.

FIG. 8 is a diagram showing an example of a display image displayed on the image forming apparatus according to an embodiment of the present disclosure.

FIG. 9 is a diagram showing an example of a display image displayed on the image forming apparatus according to an embodiment of the present disclosure.

FIG. 10 is a diagram showing an example of a display image displayed on the image forming apparatus according to an embodiment of the present disclosure.

FIG. 11 is a diagram showing an example of a display image displayed on the image forming apparatus according to an embodiment of the present disclosure.

FIG. 12 is a diagram showing an example of a display image displayed on the image forming apparatus according to an embodiment of the present disclosure.

FIG. 13 is a flowchart showing an example of the procedure of an operation mode control process executed by the image forming apparatus according to an embodiment of the present disclosure.

FIG. 14 is a flowchart showing an example of the procedure of a handwritten character input process executed by the image forming apparatus according to an embodiment of the present disclosure.

### DETAILED DESCRIPTION

The following describes an embodiment of the present disclusure with reference to the attached drawings. It should be noted that the following embodiment is an example of a specific embodiment of the present disclosure and should not limit the technical scope of the present disclosure.

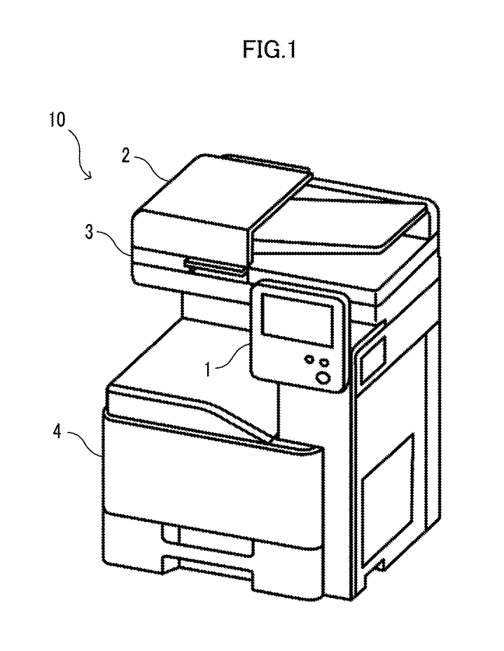

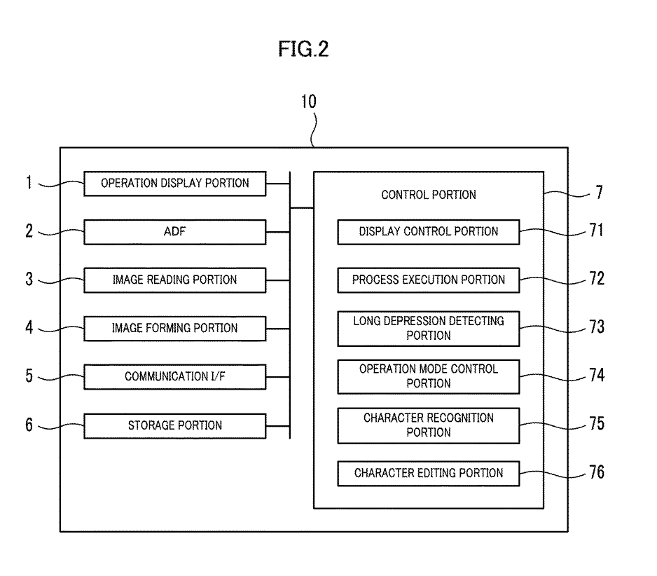

As shown in FIG. 1 and FIG. 2, an image forming apparatus 10 according to an embodiment of the present disclosure includes an operation display portion 1, an ADF 2, an image reading portion 3, an image forming portion 4, a communication I/F 5, a storage portion 6, and a control portion 7. Specifically, the image forming apparatus 10 is a multifunction peripheral having a plurality of functions such as a printer function, a scanner function, a copy function, and a facsimile function. It is noted that the image forming apparatus 10 according to an embodiment of the present disclosure is not limited to a multifunction peripheral, but may be an image reading device for generating image data by reading an image within a reading range including a document sheet, or an image forming apparatus including the image reading device. It is noted that a combination of the operation display portion 1 and the control portion 7 of the image forming apparatus 10 corresponds to the handwritten character input device of the present disclosure.

The operation display portion 1 includes a display portion and an operation portion, wherein the display portion is a liquid crystal display or the like for displaying information, and the operation portion is composed of a touch panel and operation buttons for receiving user operations. The operation display portion 1 can simultaneously detect at least two touch positions on the screen. The ADF 2 is an automatic document feeder that includes a document sheet setting portion, a conveyance roller, a document sheet pressing, and a sheet discharge portion, and feeds a document sheet so that the document sheet can be read by the image reading portion 3. The image reading portion 3 includes a document sheet table, a light source, a mirror, an optical lens, and a CCD (Charge Coupled Device), and can read an image within a reading range including a document sheet and output the read image as the image data.

The image forming portion 4 can execute a printing process by the electrophotography or the inkjet method to form an image on a sheet based on the image data. As one example, when the image forming portion 4 is an electrophotographic image forming portion, the image forming portion 4 includes a photoconductor drum, a charger, an exposure device, a transfer device, and a fixing device.

The communication I/F 5 is a communication interface that can execute a communication process of performing a communication with an external information processing apparatus such as a facsimile apparatus or a personal computer via a communication network such as a telephone line, the Internet, or a LAN, in accordance with a predetermined communication protocol.

The storage portion 6 is a nonvolatile storage portion such as a hard disk or EEPROM. The storage portion 6 stores various control programs, character recognition pattern data, and image data that are used for an operation mode control process and a handwritten character input process executed by the control portion 7, wherein the operation mode control process and the handwritten character input process are described below.

The control portion 7 includes control equipment such as CPU, ROM, and RAM. The CPU is a processor that executes various calculation processes. The ROM is a nonvolatile storage portion in which various information such as control programs for causing the CPU to execute various processes are stored in advance. The RAM is a volatile or nonvolatile storage portion that is used as a temporary storage memory (working area) for the various processes executed by the CPU.

Specifically, the control portion 7 includes a display control portion 71, a process execution portion 72, a long depression detecting portion 73, an operation mode control portion 74, a character recognition portion 75, and a character editing portion 76. It is noted that the control portion 7 functions as each of the processing portions by executing various processes in accordance with the control programs. In addition, the control portion 7 may include an electronic circuit that realizes part or all of processing functions of the processing portions.

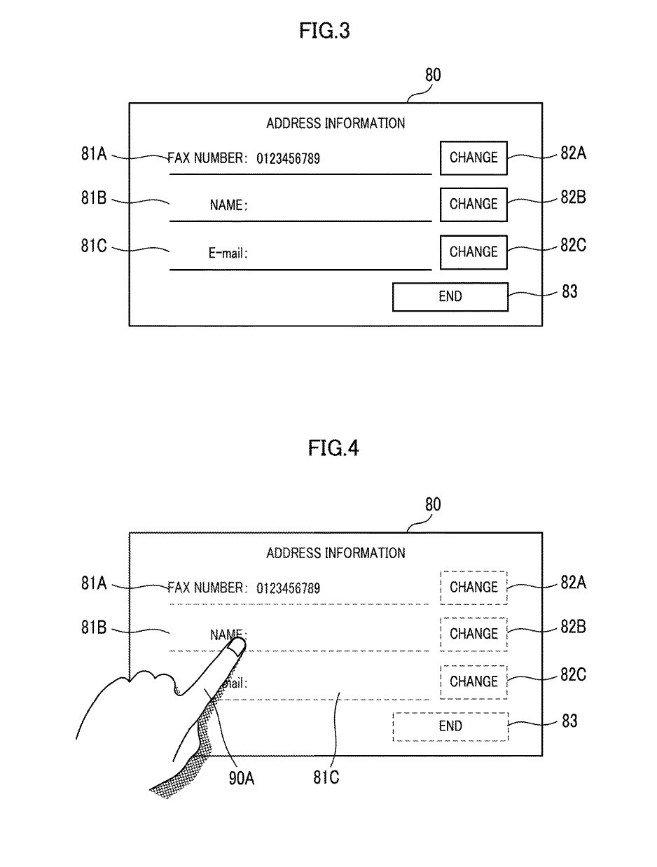

The display control portion 71 displays various information on the operation display portion 1, and displays touch operation targets such as buttons or icons that are touch operated by the user. For example, the display control portion 71 displays an address information setting screen 80 shown in FIG. 3 on the operation display portion 1 in response to an instruction by the user. On the address information setting screen 80, a plurality of character input columns 81A to 81C and a plurality of buttons 82A to 82C and 83 are displayed. The plurality of character input columns 81A to 81C and buttons 82A to 82C and 83 are an example of the touch operation targets.

The process execution portion 72, in response to a touch operation performed to a touch operation target, executes a process associated with the touch operation target. For example, when a touch operation is performed to the button 82B displayed on the address information setting screen 80 shown in FIG. 3, the process execution portion 72 calls a software keyboard function which is used to input a name to the character input column 81B. As another example, when a touch operation is performed to the button 83 displayed on the address information setting screen 80 shown in FIG. 3, the process execution portion 72 closes the address information setting screen 80.

The long depression detecting portion 73 detects a long depression operation performed to the operation display portion 1. The long depression operation is an operation of holding a state where an indicator such as a finger or a touch pen is touched to the screen of the operation display portion 1. For example, the long depression detecting portion 73 detects a long depression operation when the indicator has been touched to the operation display portion 1 for a predetermined time period or more.

The operation mode control portion 74, while the long depression detecting portion 73 is detecting a long depression operation performed with a first indicator (for example, a finger of the left hand), receives a handwritten character input operation performed to the operation display portion 1 with a second indicator (for example, a finger of the right hand). That is, the operation mode control portion 74 starts receiving a handwritten character input operation in response to a start of a long depression operation, and ends receiving the handwritten character input operation in response to an end of the long depression operation. The handwritten character input operation is an operation of writing characters (including numerals and signs) with an indicator such as a finger or a touch pen on the screen of the operation display portion 1 as shown in FIG. 5.

The character recognition portion 75 recognizes a handwritten character input by the handwritten character input operation and converts the recognized handwritten character to a character code. For example, the character recognition portion 75 compares a track of touch detected by the operation display portion 1 with the character recognition pattern data stored in the storage portion 6 in advance and determines a character code that corresponds to the track of touch. The display control portion 71 displays an input character string on the operation display portion 1 based on the character code converted by the character recognition portion 75 from the handwritten character. It is noted that the character recognition portion 75 can recognize an editing operation pattern that is used to edit the input character string, as well as the handwritten character. The editing operation pattern includes a deletion operation pattern for deleting at least one character from the input character string, and a character type conversion operation pattern for converting the character type of at least one character of the input character string. The character type conversion operation pattern includes, for example, a pattern for converting a lowercase character to an uppercase character, and a pattern for converting an uppercase character to a lowercase character.

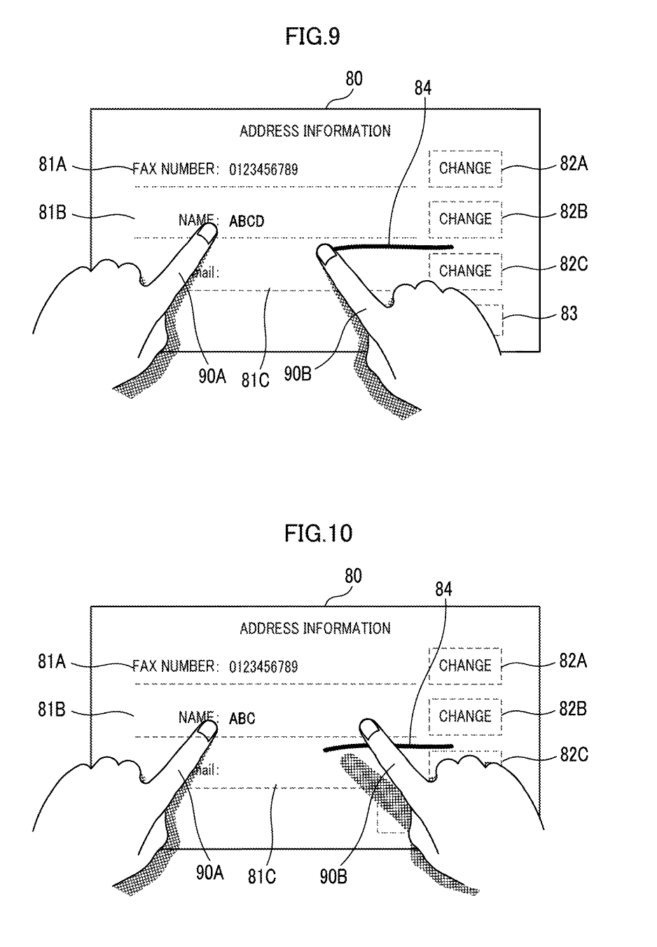

The character editing portion 76 edits an input character string in response to an editing operation pattern recognized by the character recognition portion 75. For example, the character editing portion 76 deletes at least one character from the input character string in response to a deletion operation pattern recognized by the character recognition portion 75. In addition, for example, the character editing portion 76 converts the character type of at least one character of the input character string in response to a character type conversion operation pattern recognized by the character recognition portion 75. It is noted that the character editing portion 76 may execute one of different processes depending on whether the editing operation pattern was input by a one-point-touch operation (see FIG. 9) or a two-point-touch operation (see FIG. 11). For example, the character editing portion 76 may delete the last one character of the input character string in response to a deletion operation pattern input by the one-point-touch operation (namely, a touch operation performed with a finger or a touch pen), and delete all characters of the input character string in response to a deletion operation pattern input by the two-point-touch operation (namely, simultaneous touches of two fingers or two touch pens). In addition, the character editing portion 76 may selectively execute the deletion of the input character or the conversion of the character type based on the movement direction (for example, a left-right direction or an up-down direction) of the track of touch of the one-point-touch operation or the two-point-touch operation.

Next, a description is given of how the image forming apparatus 10 operates in response to an input of a handwritten character, with reference to FIG. 3 to FIG. 12.

The display control portion 71, in response to an instruction from the user, displays the address information setting screen 80 on the operation display portion 1 as shown in FIG. 3. On the address information setting screen 80, three character input columns 81A to 81C are displayed. In the character input columns 81A to 81C, information of the “fax number”, “name”, and “e-mail” that are registered in the image forming apparatus 10 are displayed, respectively. It is noted that, in the example of FIG. 3, information of the “name” and “e-mail” have not been registered yet. The user can newly register or change the information of the character input columns 81A to 81C by two methods. The first method is to use a software keyboard. The second method is to use handwriting.

When any of the buttons 82A to 82C is touched by the user, a software keyboard function is called by the process execution portion 72, and a software keyboard is displayed on the operation display portion 1. The user can operate the displayed software keyboard to add a character string in a character input column corresponding to the touched button, change the character string in the character input column, or delete the character string from the character input column. It is noted that inputting characters via the software keyboard is a well-known technology, and a detailed description thereof is omitted here.

The following describes the operation of the image forming apparatus 10 in the case where the user adds a character to a desired character input column by handwriting, with reference to FIG. 4 to FIG. 8. In this example, the user inputs a name to the character input column 81B.

As shown in FIG. 4, when the user performs a long depression operation on the character input column 81B with a first indicator 90A such as a finger or a touch pen, the long depression operation is detected by the long depression detecting portion 73. The operation mode control portion 74 receives the handwritten character input operation while the long depression detecting portion 73 is detecting the long depression operation. The operation mode control portion 74 switches the operation mode of the image forming apparatus 10 from a normal mode to a handwritten character input mode when a touch operation on the character input column 81B continues for a predetermined time period or more. It is noted that, as a modification, the operation mode control portion 74 may switch the operation mode of the image forming apparatus 10 immediately upon detection of a touch operation on the character input column 81B, from the normal mode to the handwritten character input mode. The handwritten character input mode continues until the long depression operation ends, namely, until the first indicator 90A is separated from the operation display portion 1.

As shown in FIG. 4, in the handwritten character input mode, the density of the display images on the operation display portion 1, namely, the density of the address information setting screen 80 becomes lighter than in the normal mode. That is, when the operation mode control portion 74 starts receiving a handwritten character input operation, the display control portion 71 temporarily lighten the density of the display images (for example, characters, lines, buttons, icons, and the background) displayed on the operation display portion 1. Subsequently, when the operation mode control portion 74 ends receiving the handwritten character input operation, the display control portion 71 returns the density of the display images to the original density. With this operation, the user can easily recognize whether the current operation mode is the normal mode or the handwritten character input mode.

It is noted that, as a modification, in the handwritten character input mode, the display control portion 71 may display, on the operation display portion 1, a message such as “IN HANDWRITTEN CHARACTER INPUT MODE” or an image indicating that it is in the handwritten character input mode. In addition, in the handwritten character input mode, the display control portion 71 may color the whole screen of the operation display portion 1 to a predetermined color such as white. Furthermore, in the handwritten character input mode, the display control portion 71 may lighten the density of display images other than the character input column 81B that is the input target, while maintaining the density of the character input column 81B (for example, the density of the input character string).

As shown in FIG. 5, in the handwritten character input mode, the user can input a handwritten character by performing a handwritten character input operation with a second indicator 90B that is different from the first indicator 90A. While the operation mode control portion 74 receives a handwritten character input operation, the process execution portion 72 does not execute a process associated with the touch operation target even if a touch operation is performed to the touch operation target. That is, in the handwritten character input mode, touch operations to the buttons 82A to 82C and 83 are invalid. As a result, as shown in FIG. 5, the user can input a handwritten character at his/her will by using the whole screen of the operation display portion 1 without worrying about the positions of the buttons 82A to 82C and 83.

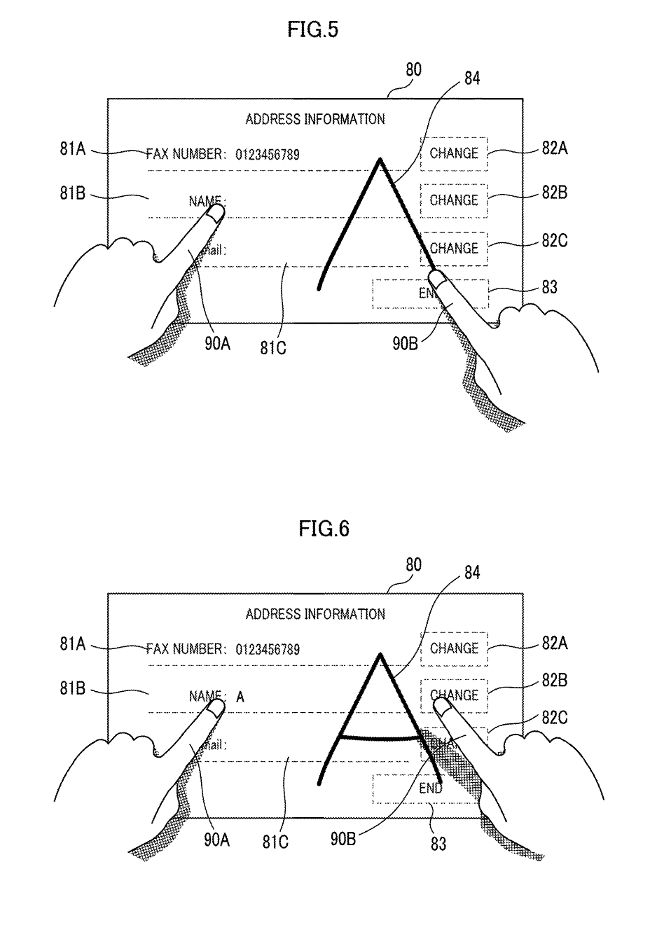

As shown in FIG. 6, when the user completes writing one character by handwriting, the character recognition portion 75 recognizes the handwritten character, and the handwritten character is converted to a character code. The display control portion 71 displays, based on the character code, the input character string in a character input column (in this example, the character input column 81B) that corresponds to the touch position of the long depression operation. It is noted that when the current touch position of the first indicator 90A is shifted from the original touch position as of the start of the long depression operation performed with the first indicator 90A, it is preferable that the display control portion 71 displays the input character string in the character input column that corresponds to the original touch position as of the start of the long depression operation. With this configuration, in the handwritten character input mode, it is possible to fix the character input column as the input target, while allowing the user to move the touch position of the first indicator 90A at his/her will. This makes it possible for the user to, for example, perform a handwritten character input operation with the second indicator 90B while moving, as necessary, the first indicator 90A to a position not forming any obstacle.

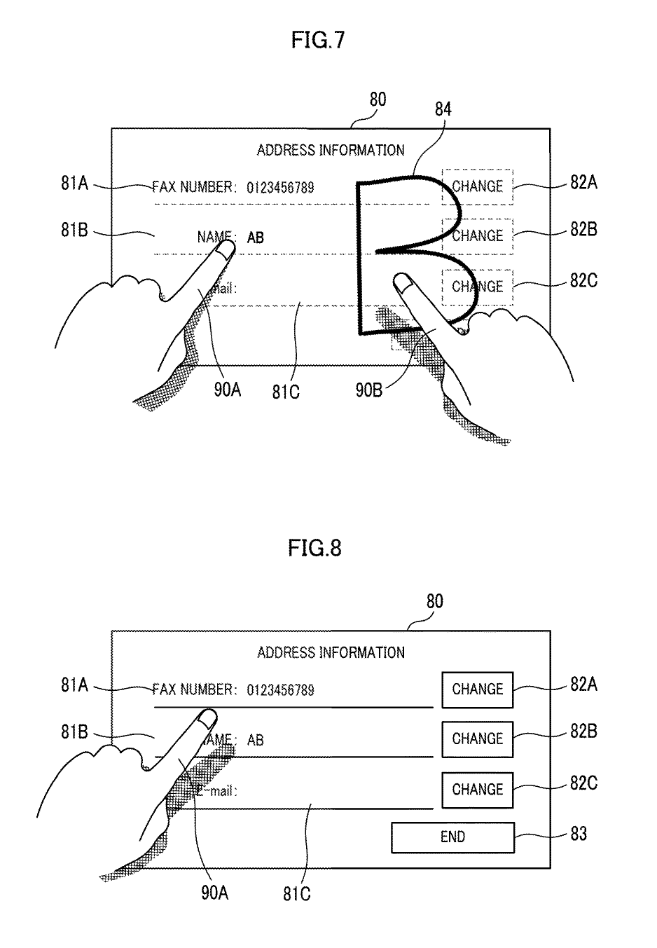

It is noted that even if the second indicator 90B is separated from the operation display portion 1, the handwritten character input mode continues as far as the first indicator 90A is in touch with the operation display portion 1. As a result, as shown in FIG. 7, the user can input a plurality of handwritten characters in sequence while the long depression operation with the first indicator 90A is continued.

Subsequently, when the first indicator 90A is separated from the operation display portion 1 as shown in FIG. 8, the handwritten character input mode ends. That is, the operation mode control portion 74 switches the operation mode of the image forming apparatus 10 from the handwritten character input mode to the normal mode when the long depression detecting portion 73 no longer detects the long depression operation. The display control portion 71 then returns the density of the display images of the operation display portion 1 to the original density.

According to the description so far, characters can be input to the character input column 81B in the state where no character string has been input. However, characters can be added to the character input column 81B even in the state where a character string has already been input. In that case, for example, when the long depression operation is performed to a character input column in the state where a character string is displayed in the character input column, the display control portion 71 may add, to the end of the character string that corresponds to the touch position of the long depression operation, an input character string that is input by the handwritten character input operation. Alternatively, when the long depression operation is performed to a character input column in the state where a character string is displayed in the character input column, the display control portion 71 may add, to a position in the character string that corresponds to the touch position of the long depression operation, an input character string that is input by the handwritten character input operation. Specifically, for example, in FIG. 3, when a long depression operation is performed to a boundary between fax numbers “3” and “4” in the character input column 81A, and “8” is input by a handwritten character input operation, the display control portion 71 may insert “8” between “3” and “4”.

Next, a description is given of how the image forming apparatus 10 operates when the user deletes a character from a desired character input column, with reference to FIG. 9 to FIG. 12. In this example, the user deletes a character from the character input column 81B.

In the handwritten character input mode, the user can delete an already-input character by inputting a predetermined deletion operation pattern (for example, a leftward straight line) by handwriting. For example, as shown in FIG. 9, when a leftward straight line is input with the second indicator 90B to the character input column 81B while the image forming apparatus 10 is in the handwritten character input mode, the character recognition portion 75 can recognize that the track of touch is the deletion operation pattern. It is noted that the character recognition portion 75 can determine whether the deletion operation pattern was input by the one-point-touch operation or the two-point-touch operation. In addition, the character recognition portion 75 may distinguish among, for example, a flick operation, a swipe operation, and a slide operation based on the movement speed of the touch position during the input of the track of touch, as well as based on the shape of the track of touch. In addition, the method of deleting a character may be changed depending on whether the movement direction of the touch position during the input of the track of touch is leftward or rightward. For example, when a leftward straight line is input, the last one character of the input character string may be deleted, and when a rightward straight line is input, all characters of the input character string may be deleted.

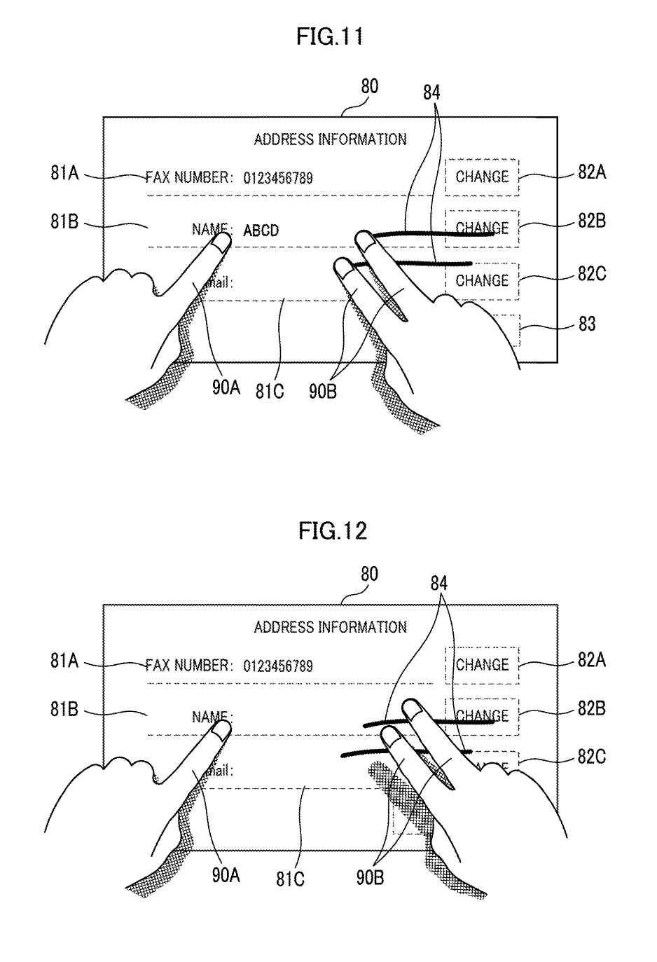

As shown in FIG. 9, when a deletion operation pattern is input by the one-point-touch operation in the state where, for example, an input character string of four characters is displayed in the character input column 81B, the character editing portion 76 deletes the last one character of the input character string as shown in FIG. 10. In addition, as shown in FIG. 11, when the deletion operation pattern is input by the two-point-touch operation in the state where an input character string of, for example, four characters is displayed in the character input column 81B, the character editing portion 76 deletes all characters of the input character string as shown in FIG. 12.

Meanwhile, there is known a handwritten character input device to which handwritten characters can be input via a pointing device such as a touch panel. In general, when inputting handwritten characters to this kind of handwritten character input device, the user calls a handwritten character input screen by tapping a handwritten character input start button or the like displayed on the screen. In addition, after completing input of the handwritten characters, the user closes the input screen by tapping a close button or the like. However, in such a handwritten character input device, the user needs to search for, find, and tap predetermined buttons to open and close the handwritten character input screen. This prevents the user from quickly inputting a handwritten character. It is noted that there is known a handwritten character input device that recognizes a handwriten character input to a predetermined handwritten character input area, and displays the recognition result in a recognition result display area. However, in such a handwritten character input device, a predetermined handwritten character input area needs to be displayed in the screen, which reduces the display area.

On the other hand, according to the image forming apparatus 10 of the present embodiment, a handwritten character input operation performed with the second indicator 90B to the operation display portion 1 is received while the long depression detecting portion 73 is detecting a long depression operation performed with the first indicator 90A. This makes it possible for the user to quickly input a handwritten character without reducing the display area.

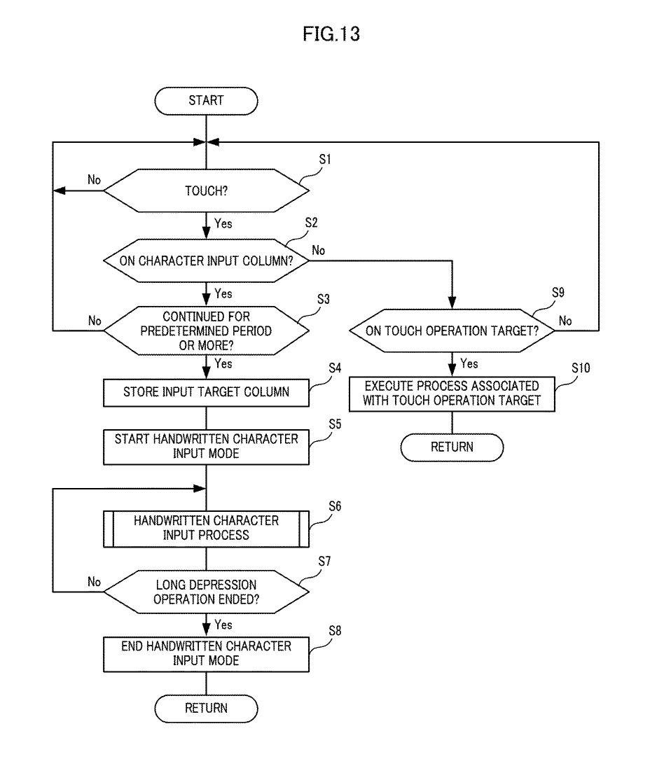

The following describes an example of the procedure of the operation mode control process that is executed by the control portion 7, with reference to FIG. 13. Here, steps S1, S2, . . . represent numbers assigned to the processing procedures (steps) executed by the control portion 7. It is noted that the operation mode control process is, for example, started in response to a power-on of the image forming apparatus 10, and is ended in response to a power-off of the image forming apparatus 10.

<Step S1>

First, in step S1, it is determined by the control portion 7 whether or not a touch operation has been performed to the operation display portion 1, based on a signal from the operation display portion 1. When it is determined that a touch operation has been performed to the operation display portion 1 (S1: Yes), the process moves to step S2. On the other hand, when it is determined that a touch operation has not been performed to the operation display portion 1 (S1: No), the process of step S1 is repeated until it is determined that a touch operation has been performed to the operation display portion 1.

<Step S2>

In step S2, it is determined by the control portion 7 whether or not the touch position of the touch operation is on a character input column. When it is determined that the touch position of the touch operation is on a character input column (S2: Yes), the process moves to step S3. On the other hand, when it is determined that the touch position of the touch operation is not on a character input column (S2: No), the process moves to step S9.

<Step S3>

In step S3, it is determined by the control portion 7 whether or not the touch operation has continued for a predetermined time period or more. When it is determined that the touch operation has continued for the predetermined time period or more (S3: Yes), the process moves to step S4. On the other hand, when it is determined that the touch operation has not continued for the predetermined time period or more (S3: No), the process returns to step S1.

<Step S4>

In step S4, the control portion 7 stores the character input column corresponding to the touch position of the touch operation on the RAM or the like, as the input target column.

<Step S5>

In step S5, the control portion 7 starts the handwritten character input mode. At this time, the control portion 7 temporarily lightens the density of the display images displayed on the operation display portion 1.

<Step SG>

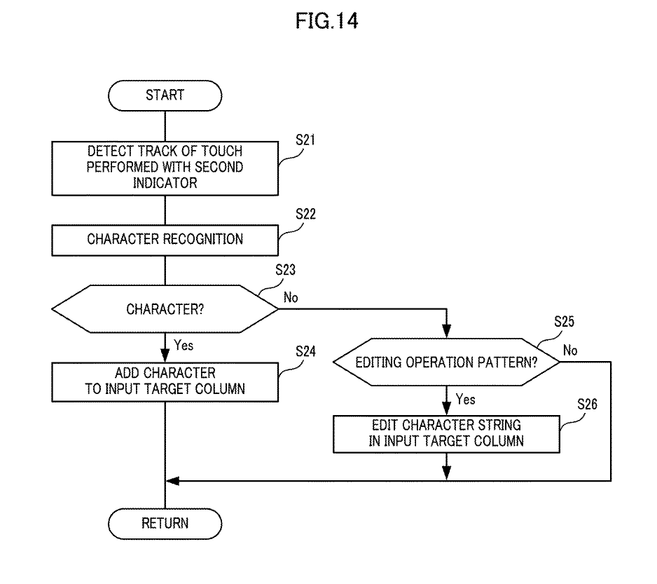

In step S6, the control portion 7 executes the handwritten character input process. It is noted that the handwritten character input process is described in detail below with reference to the flowchart of FIG. 14.

<Step S7>

In step S7, it is determined by the control portion 7 whether or not a long depression operation with the first indicator 90A has ended. When it is determined that the long depression operation has ended (S7: Yes), the process moves to step S8. On the other hand, when it is determined that the long depression operation has not ended (S7: No), the handwritten character input process of step S6 is continued until it is determined that the long depression operation has ended.

<Step S8>

In step S8, the control portion 7 ends the handwritten character input mode. At this time, the control portion 7 returns the density of the display images to the original density. The process then returns to step S1.

<Step S9>

In step S9, it is determined by the control portion 7 whether or not the touch position of the touch operation is on a touch operation target. When it is determined that the touch position of the touch operation is on a touch operation target (S9: Yes), the process moves to step S10. On the other hand, when it is determined that the touch position of the touch operation is not on a touch operation target (S9: No), the process returns to step S1.

<Step S10>

In step S10, the control portion 7 executes a process associated with the touch operation target on which the touch position of the touch operation is. The process then returns to step S1.

It is noted that processes of the steps S1, S3 and S7 (long depression detecting step) are executed by the long depression detecting portion 73 of the control portion 7. In addition, processes of the steps S5 and S8 (operation mode control step) are executed by the operation mode control portion 74 of the control portion 7.

Next, the following describes an example of the procedure of the handwritten character input process that is executed by the control portion 7 in the step S6, with reference to FIG. 14.

<Step S21>

First, in step S21, the control portion 7 detects a track of touch performed with the second indicator 90B which is different from the first indicator 90A that is performing the long depression operation, based on a signal from the operation display portion 1.

<Step S22>

In step S22, the control portion 7 executes a character recognition process of comparing the track of touch with pattern data (the character recognition pattern data and the editing operation pattern data) stored in the storage portion 6 in advance.

<Step S23>

In step S23, it is determined by the control portion 7 whether or not the track of touch represents a character. When it is determined that the track of touch represents a character (S23: Yes), the process moves to step S24. On the other hand, when it is determined that the track of touch does not represent a character (S23: No), the process moves to step S25.

<Step S24>

In step S24, the control portion 7 adds the character to the character input column. Specifically, the control portion 7 adds a character code of the character represented by the track of touch to input character string data corresponding to the character input column. As a result, the character represented by the track of touch is added to the character input column displayed on the operation display portion 1. The process then returns to step S21.

<Step S25>

In step S25, it is determined by the control portion 7 whether or not the track of touch represents an editing operation pattern. When it is determined that the track of touch represents an editing operation pattern (S25: Yes), the process moves to step S26. On the other hand, when it is determined that the track of touch does not represent an editing operation pattern (S25: No), the process returns to step S21.

<Step S26>

In step S26, the control portion 7 edits the character string in the character input column. Specifically, the control portion 7 changes or deletes the character string in the character input column in response to the editing operation pattern represented by the track of touch. For example, when the track of touch represents the deletion operation pattern input by the one-point-touch operation, the control portion 7 deletes the last one character of the input character string in the character input column. In addition, for example, when the track of touch represents the character type conversion operation pattern for converting an uppercase character to a lowercase character, the control portion 7 converts the character code of the last character of the input character string in the character input column from the character code of the uppercase character to the character code of the lowercase character. The process then returns to step S21.

It is noted that although, in the present embodiment, the present disclosure is applied to an image forming apparatus, the present disclosure is not limited thereto, but is applicable to an arbitrary input device that includes an operation display portion that can simultaneously detect at least two touch positions. However, considering that two indicators are used to input a handwritten character, the present disclosure is particularly suitable for inputting a handwritten character via an operation display portion of a stationary apparatus such as the operation display portion 1 of the image forming apparatus 10.

In addition, in the present embodiment, a handwritten character input via the operation display portion 1 is subjected to a character recognition process. However, the present disclosure is not limited to this configuration. For example, the present disclosure is applicable to a configuration where a handwritten signature or a handwritten memo is stored as image data without being converted to character code(s).

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A handwritten character input device comprising:
an operation display portion configured to simultaneously detect at least two touch positions;
a long depression detecting portion configured to detect a long depression operation performed to the operation display portion; and
an operation mode control portion configured to, while the long depression detecting portion is detecting the long depression operation performed with a first indicator, receive a handwritten character input operation performed to the operation display portion with a second indicator.

2. The handwritten character input device according to claim 1 further comprising:
a display control portion configured to display a plurality of character input columns on the operation display portion; and
a character recognition portion configured to recognize a handwritten character which is input by the handwritten character input operation and convert the recognized handwritten character to a character code, wherein
the display control portion displays, based on the character code, an input character string in a character input column that corresponds to a touch position of the long depression operation.

3. The handwritten character input device according to claim 2, wherein
the display control portion displays the input character string in a character input column that corresponds to an original touch position as of a start of the long depression operation.

4. The handwritten character input device according to claim 2, wherein
the character recognition portion can recognize, as well as the handwritten character, an editing operation pattern that is used to edit the input character string, and
the handwritten character input device further comprises:
a character editing portion configured to edit the input character string in response to the editing operation pattern recognized by the character recognition portion.

5. The handwritten character input device according to claim 4, wherein
the editing operation pattern includes a deletion operation pattern for deleting at least one character from the input character string.

6. The handwritten character input device according to claim 5, wherein
the character editing portion deletes a last character of the input character string in response to a deletion operation pattern input by a one-point-touch operation, and deletes all characters of the input character string in response to a deletion operation pattern input by a two-point-touch operation.

7. The handwritten character input device according to claim 4, wherein
the editing operation pattern includes a character type conversion operation pattern for converting a character type of at least one character of the input character string.

8. The handwritten character input device according to claim 2, wherein
when the long depression operation is performed to the character input column in a state where a character string is displayed in the character input column, the display control portion adds, to a position in the character string that corresponds to the touch position of the long depression operation, the input character string that is input by the handwritten character input operation.

9. The handwritten character input device according to claim 2, wherein
the display control portion displays a touch operation target on the operation display portion,
the handwritten character input device further comprises:
a process execution portion configured to execute a process associated with the touch operation target, in response to a touch operation performed to the touch operation target, and
while the operation mode control portion receives the handwritten character input operation, the process execution portion does not execute the process associated with the touch operation target even if the touch operation is performed to the touch operation target.

10. The handwritten character input device according to claim 9, wherein
when the operation mode control portion starts receiving the handwritten character input operation, the display control portion temporarily lightens density of display images displayed on the operation display portion, and then when the operation mode control portion ends receiving the handwritten character input operation, the display control portion returns the density of the display images to original density.

11. The handwritten character input device according to claim 1 further comprising:
a display control portion configured to display a touch operation target on the operation display portion; and
a process execution portion configured to execute a process associated with the touch operation target, in response to a touch operation performed to the touch operation target, wherein
while the operation mode control portion receives the handwritten character input operation, the process execution portion does not execute the process associated with the touch operation target even if the touch operation is performed to the touch operation target.

12. The handwritten character input device according to claim 11, wherein
when the operation mode control portion starts receiving the handwritten character input operation, the display control portion temporarily lightens density of display images displayed on the operation display portion, and then when the operation mode control portion ends receiving the handwritten character input operation, the display control portion returns the density of the display images to original density.

13. An image forming apparatus comprising:
the handwritten character input device according to claim 1; and
an image forming portion configured to form an image on a sheet based on image data.

14. A handwritten character input method comprising:
a long depression detecting step of detecting a long depression operation performed to an operation display portion which is configured to simultaneously detect at least two touch positions; and
an operation mode control step of, while the long depression operation performed with a first indicator is detected in the long depression detecting step, receiving a handwritten character input operation that is performed to the operation display portion with a second indicator.
